(19) United States
(12) Patent Application Publication
(10) Pub. No.: US 2014/0240515 A1
(43) Pub. Date: Aug. 28, 2014

(54) MOTION PICTURE CAMERA AND METHOD FOR TAKING A SEQUENCE OF MOVING IMAGES

(71) Applicant: Arnold & Richter Cine Technik GmbH & Co. Betriebs KG, Munich (DE)

(72) Inventor: Johannes Steurer, Landshut (DE)

(73) Assignee: Arnold & Richter Cine Technik GmbH & Co. Betriebs KG, Munich (DE)

(21) Appl. No.: 14/190,224

(22) Filed: Feb. 26, 2014

(30) Foreign Application Priority Data
Feb. 28, 2013 (DE) DE 102013203425.3

(51) Int. Cl. H04N 5/225; H04N 5/235; H04N 5/33

(52) U.S. Cl. CPC H04N 5/2258; H04N 5/33; H04N 5/2353
USPC 348/168; 348/262; 348/222.1; 348/218.1

(57) ABSTRACT

A digital motion picture camera for taking a sequence of moving images comprises a rotating mirror sector shutter which alternately transmits a received optical path of the motion picture camera as a first imaging optical path and deflects the received optical path as a second imaging optical path; a first image sensor arranged in the first imaging optical path for generating radiation-dependent first image signals; and a second image sensor arranged in the second imaging optical path for producing radiation-dependent second image signals.

### CROSS-REFERENCE TO RELATED APPLICATIONS

This application claims priority of German Patent Application DE 10 2013 203 425.3 filed on Feb. 28, 2013.

### FIELD OF THE INVENTION

The invention relates to a digital motion picture camera for taking a sequence of moving images as well as to a method for taking a sequence of moving images.

### BACKGROUND OF THE INVENTION

A digital motion picture camera is generally designed in accordance with an analog motion picture camera, with the digital motion picture camera having an image sensor instead of a film to be exposed which converts incident radiation directly into electronic image signals. For this purpose, the image sensor comprises a plurality of radiation-sensitive sensor elements (pixels) which are typically arranged in rows and columns. Light or other radiation of a scene to be recorded by the motion picture camera enters into the motion picture camera along an optical path and is incident onto the image sensor. As such, the term “moving image” as used herein denotes the information included in or derived from the sensor signals generated by the sensor elements of the respective image sensor for a respective fixedly defined time period. In this respect, the optical path can be conducted or deflected by different optical elements such as lenses and mirrors. An objective at the inlet of the motion picture camera and thus at the start of the optical path in particular serves for the focused imaging of the scene onto the image sensor. The objective can in this respect be a fixed element of the motion picture camera. In the area of professional cinematic film shots, in contrast, interchangeable objectives or lenses are, in contrast, generally used which can be selectively connected to the motion picture camera.

The radiation entering into the motion picture camera is typically not continuously sensed and converted into image signals. Individual moving images are rather generated in a fast sequence whose image signals are produced from the radiation which is incident from the gathered scene onto the image sensor within a respective fixedly defined time period (exposure time). In this respect, the individual moving images or exposure times do not follow one another directly since a time period is required for the reading and resetting of the image sensor between the individual exposures (corresponding to the time period for the film transport in analog motion picture cameras). Regular exposure phases in which radiation-dependent image signals are produced thus alternate with dark phases in which no image signals are produced. The number of moving images per second (frame rate) then results from the reciprocal value of the duration for an exposure phase and a dark phase.

The change between an exposure phase and a dark phase can take place electronically, e.g. by activating or deactivating the sensor elements of the image sensor. The change in contrast preferably (or also exclusively) takes place) mechanically by a selective blocking and releasing of the optical path in the motion picture camera. For this purpose, a rotating sector shutter can be used which is divided, starting from a basic circular shape, into at least two sectors of which one is permeable for the radiation and the other is impermeable for the radiation.

By an eccentric arrangement of such a rotating sector shutter in the optical path, the optical path can thus be alternately blocked by a radiation-impermeable sector of the shutter or transmitted through a radiation-permeable sector. The rotational frequency of the sector shutter and the relative size of the sectors with respect to one another, which is characterized by the central angle of a respective sector, then determine the frame rate and the respective durations of the exposure phase and the dark phase. For example, a sector shutter can have exactly one radiation-permeable sector having a central angle (opening angle) of 180° as well as exactly one radiation-impermeable sector having a correspondingly remaining central angle of likewise 180° and can rotate, for example, at 24 or 25 revolutions per second. A frame rate of 24 or 25 frames per second respectively results from this, with the exposure time then amounting to 1/48th of a second or 1/50th of a second. The sector shutter is preferably not only adjustable with respect to the rotational frequency, but also with respect to the size of the radiation-permeable sector in that different opening angles can be set, for example from 11° to 180°, to achieve different exposure times with different frame rates.

The image sensor onto which the radiation is incident with a released optical path is typically suitable to sense visible light and to convert it into corresponding image signals. Generally, however, radiation of other spectral ranges can also enter into the motion picture camera via the same optics and the same optical path and thus provide supplementary information on the scene to be recorded. Infrared radiation (in particular near-infrared radiation) likewise in particular enters into the camera. To prevent this radiation from falsifying the moving image generated from the image signals of the image sensor, an infrared blocking filter which filters the spectral portions having a wavelength above the visible spectral range can be associated with said image. In this manner, the information contained in the infrared radiation is discarded and remains unused.

### SUMMARY OF THE INVENTION

It is an object of the invention to provide a digital motion picture camera for taking a sequence of moving images as well as a corresponding method with which a plurality of different information on a scene to be recorded can be taken by the motion picture camera.

The object is satisfied by a digital motion picture camera comprising a rotating mirror sector shutter which alternately transmits a received optical path of the motion picture camera as a first imaging optical path and deflects the received optical path as a second imaging optical path; a first image sensor arranged in the first imaging optical path for producing radiation-dependent first image signals; and a second image sensor arranged in the second imaging optical path for producing radiation-dependent second image signals.

The digital motion picture camera therefore does not only comprise a single image sensor, but rather two electronic images sensors which can generate respective image signals in dependence on the incident radiation. In this respect, separate optical paths are provided at least in part for the two image sensors. However, the radiation incident onto the image sensors first enters into the motion picture camera via a received optical path common to both image sensors. This received optical path in particular extends from an objective present at the motion picture camera or optionally connected to the motion picture camera up to the rotating mirror sector shutter. The received optical path is then split by the mirror sector shutter in a time-multiplexed manner and conducted onward alternately as a first image optical path and as a second image optical path respectively. For this purpose, the radiation-impermeable sectors of the mirror sector shutter are mirror coated. In this manner, the radiation conducted along the received optical path to the mirror sector shutter is either transmitted through a radiation-permeable sector of the mirror sector shutter and conducted onward along the first imaging optical path to the first image sensor or is it deflected by a reflecting radiation-impermeable sector of the mirror sector shutter along the second imaging optical path to the second image sensor.

It is made possible by this arrangement that two image sensors, which can in particular sense information of different types from the respective incident radiation and convert it into respective image signals, are integrated in a single motion picture camera. In this respect, it is ensured by the common received optical path that substantially the same radiation is conducted alternately to the one or the other image sensor. The scene to be recorded is thus generally sensed by both image sensors from the same angle of view and with the same optical parameters which can be predefined, for instance, by optical elements in the received optical path, in particular by an objective connected to the motion picture camera, for example, an aperture opening, a focus, a zoom or an optical filtering. All changes to the objective, such as its replacement or a change in the focal length, in the angle of view or in the iris diaphragm act equally on both sensors. This property is of great economic importance for motion picture shots since the objective properties are frequently changed in the course of shooting and this necessarily has identical consequences for both image sensors with the described arrangement. After such a change of optical parameters of the received optical path, no separate adjustment of the second image sensor with respect to the first image sensor is therefore required.

The one of the two image sensors can correspond to an image sensor which (as usual with motion picture cameras with a single image sensor) is sensitive to colors of the visible spectral range (for example for red, green and blue). The other image sensor in contrast can additionally sense further going information from the radiation (monochromatically or multispectrally).

The first image sensor is preferably sensitive in a first spectral range and the second image sensor is sensitive in a second spectral range, with the first spectral range and the second spectral range differing in part or in full. This means that one of the spectral ranges is at least partly not contained in the other of the spectral ranges and the two image sensors thus sense spectrally different image information. It is not precluded in this respect that the two spectral ranges partly overlap or that one is contained in the other. The two spectral ranges are preferably, however, substantially disjunct so that one of the image sensors is sensitive to wavelengths of a spectral range to which the other image sensor is not sensitive, and vice versa.

The fact that one of said image sensors is only sensitive to a specific spectral range can be an intrinsic property of the radiation-sensitive sensor elements of the image sensor. The sensitivity of an image sensor can, however, also be due to the fact that one or more filters are associated with the respective image sensor which only transmit wavelengths of a specific spectral range to the sensor elements of the image sensor. A separate color filter can in particular be associated in accordance with a defined color mosaic with each individual sensor element of the respective image sensor in the manner of a color mosaic filter such as a Bayer filter.

The first and the second image sensors in this respect do not need only to differ with respect to the spectral range, but can rather also have further differences, for example, with respect to their size, their spatial resolution (pixel number, pixel density), their readout speed, their pixel structure and pixel electronics, their aspect ratio, their sensitivity (e.g. quantum yield), their quality, their noise and/or the respective presence of separate optical elements (for example of a microlens arrangement). Both the first image sensor and the second image sensor are preferably CMOS sensors. It is, however, also possible that one or both of the image sensors is a different type of sensor, in particular e.g. a CCD sensor or a doped InGaAs sensor.

In a preferred embodiment, one of said spectral ranges substantially comprises a spectral range of visible light and the other of said spectral ranges substantially comprises a spectral range of infrared radiation, in particular near-infrared radiation. In this manner, radiation of visible light can be sensed using one of said image sensors and can be converted into corresponding image signals, whereas radiation of infrared light can be sensed and converted using the other image sensor. The spectral range of visible light in this respect extends over wavelengths from approximately 380 nm to approximately 780 nm, but can also have other thresholds, e.g. approximately 700 nm toward the top. The range of infrared radiation adjoins this with wavelengths of more than approximately 780 nm or more than approximately 700 nm, with near-infrared radiation being able to extend up to wavelengths of approximately 3 μm.

The spectral ranges in which a respective one of said image sensors converts radiation into image signals can be fixed, for example, in that a corresponding spectral filter is associated with a respective image sensor. In the last-named embodiment, a spectral short pass filter having a threshold wavelength of approximately 700 nm can be associated with the one of the image sensors, for instance, and a just complementary spectral long pass filter having a threshold wavelength of in turn approximately 700 nm can be associated with the other image sensor. Due to the quality of the filters used, a respective spectral range can have “blurred” margins at which the sensitivity of the respective image sensor deteriorates in a specific transition range. Due to these transitions, negligible overlaps can also occur in substantially disjunctive spectral ranges.

It is generally also possible that one of said image sensors does not have a spectral filter and therefore, for example, is sensitive both to visible light and to infrared radiation, whereas the spectral range in which the other image sensor is sensitive corresponds to infrared radiation and is thus contained in the spectral range of the first-named sensor. In this case the image signals of the image sensor with the comprehensive spectral range may also have infrared portions which can falsify the image information of the spectral range. This falsification can, however, be corrected by the separate sensing of the infrared information by means of the other image sensor.

In a further development a lighting device is associated with the motion picture camera for transmitting radiation (i.e. a predetermined illumination) towards a scene to be recorded by the motion picture camera. The lighting device is adapted to transmit radiation of at least one wavelength which is contained in one of said spectral ranges of sensitivity (i.e. in the first spectral range or in the second spectral range) and is not contained in the other of said spectral ranges. The scene to be recorded can thus be lit by the radiation transmitted by the lighting device. Due to the suitably selected wavelength (or wavelengths) of the transmitted radiation, the radiation of the same wavelength reflected by objects of the scene is only sensed by one of the two image sensors, whereas the other image sensor is not sensitive to this radiation. The image sensor not sensitive to this radiation can in particular be sensitive to the spectral range of visible light and can serve as in conventional motion picture cameras to sense an image of the visible image information of the scene (main image). The other image sensor can then serve to sense additional information on the scene, in particular in a non-visible spectral range (auxiliary image).

In this respect, the scene to be recorded can very generally be brightened in a specific spectral range by the radiation transmitted by the lighting device in order, for example, to increase the information yield. The lighting with said transmitted radiation can, however, also take place in a more specific manner, for instance for characterizing objects or for capturing depth information, as will be explained further below. The radiation transmitted by the lighting device can substantially only have a single wavelength, for example when the radiation is laser radiation, or can also represent a mixture of a plurality of wavelengths.

The motion picture can preferably have a lighting device associated with it which is adapted to transmit infrared radiation, in particular near-infrared radiation.

In a further development, the lighting device is adapted to mark individual objects or a plurality of objects or points within a scene to be recorded by the motion picture camera using the transmitted radiation. The lighting of objects in or points of the scene in this respect takes place selectively, with only one object or point being able to be marked by means of the transmitted radiation or also a plurality thereof simultaneously. The marking can in particular take place by means of one or more laser points.

In an embodiment, the lighting device is adapted to transmit the radiation in accordance with a predefined or adjustable spatial pattern. In other words, the scene to be recorded is not lit uniformly with the radiation transmitted by the lighting device, but a pattern, that is a fixed spatial distribution of different radiation intensity, is rather projected onto the scene to be recorded. In particular when the point from where the radiation is transmitted differs from the angle of view of the motion picture camera to the lit scene to be recorded, the pattern which can be detected from the angle of view of the camera differs from the transmitted pattern. Information on the structure, in particular the spatial structure, of the scene to be recorded can then be determined from this difference. The patterns can, for example, have horizontal or vertical stripes, substantially correspond to a chessboard pattern or can have more complex structures. The patterns are preferably irregular and not repetitive over wide regions in order to allow a spatial association of individual points of the pattern which is as unambiguous as possible. It is of particular advantage in this embodiment if the transmitted radiation is not visible (e.g. infrared) so that the visually perceptible image information is not impaired.

Alternatively or additionally, it can be advantageous if the lighting device is adapted to transmit the radiation in a predefined or adjustable manner with time modulation. For example, the modulation can comprise the radiation being transmitted by the lighting device with an intensity fluctuation in the megahertz range. Such a pulsed lighting makes it possible to determine from the phase shift between the transmitted modulation and the modular sensed by one of the image sensors the time duration which has elapsed between the transmission of the radiation by the lighting device via the reflection of the radiation at objects or points of the scene to be recorded up to the incidence of the radiation on one of the image sensors. The spacing of a respective object or point from the motion picture camera can then be determined from this time duration. In this manner, that one of the two image sensors in whose spectral range the wavelength of the transmitted radiation is incident can in particular sense depth information on the scene as additional information to the visible image information of the other image sensor. The lighting device and the respective image sensor sensitive to the wavelength of the transmitted radiation are preferably synchronized in time for this type of depth information determination. Said radiation can in particular be LED flashes or laser radiation. It is also advantageous here if the transmitted modulated radiation is not visible (e.g. infrared).

Said modulation can also comprise only transmitting the radiation (optionally having a spatial pattern) during a dark phase of one of the two image sensors, as well be explained in the following.

It is possible in all of the aforesaid embodiments and also in the embodiments named in the following that said lighting device is integrated into the motion picture camera or is connected to the motion picture camera. This is, however, not absolutely necessary and the lighting device can generally also be independent of the motion picture camera. The invention in particular also relates to a camera system having a motion picture camera of the explained kind and having an independent lighting device of the explained kind. It is, however, always preferred that a fixed spatial relationship is present between the lighting device and the motion picture camera, i.e. that the lighting device is rigidly coupled to the motion picture camera. Furthermore, said lighting device can comprise a plurality of radiation sources for transmitting said radiation which are preferably arranged in a fixed spatial relationship.

It is in particular advantageous in this respect on the determination of depth information from a time duration elapsed between the transmission and the reception of a radiation for the lighting device to be arranged in a favorable, known spatial arranged which is unchanged over time during a film shot relative to the motion picture camera. Favorable arrangements are in particular those in which the lighting of the scene using the transmitted radiation takes place from a direction substantially corresponding to the angle of view of the motion picture camera to the scene, with only a slight spacing being provided between the lighting direction and the motion picture camera.

On a use of a lighting device which transmits radiation in accordance with a predefined or adjustable spatial pattern, in contrast, a certain spacing is desired between the lighting device and the motion picture camera to be able to derive depth information from the difference in the angle of view (triangulation).

It is furthermore advantageous if the motion picture camera has a signal processing unit which is adapted to determine depth information from a comparison of the radiation transmitted by the lighting device with the image signals of one of said image sensors in whose spectral range the transmitted radiation is incident. As already presented, this comparison can in particular be based on a change in a transmitted spatial pattern and/or on a time modulation, in particular on a phase shift between the transmitted radiation and the sensed radiation. The fact can generally be utilized in this respect that a spatial pattern appears different from different angles of view or that a time modulation from different spacings is received with a different phase. Both effects can be used combined with one another or alternatively to one another for determining depth information from the image signals of one of the image sensors.

Due to the linking of image signals of the one image sensor, which comprise visible image information on the scene to be recorded, with image signals of the other image sensor, which comprise depth information on the scene, to form a respective moving image, this moving image then corresponds to a color relief image. Such a color relief image can be utilized for different applications in movie/video production such as 2D-3D conversion, the visual removal of objects or backgrounds or the subsequent insertion of objects in a scene. In said removal of objects or backgrounds due to determined depth information, the existing video information (image information in the visible spectral range) can additionally be used (e.g. edge detection). The removed objects can subsequently be used for different image manipulations which are based on the use of image masks (e.g. a virtual lighting or the interaction of real and virtual actors).

In accordance with a further advantageous embodiment, the motion picture camera can have a lighting device associated with it for transmitting at least one first lighting radiation which can in particular be the aforesaid lighting device. Furthermore, a motion picture camera can have a synchronization device associated with it which is adapted to synchronize the rotation of the mirror sector shutter and the transmission of the first lighting radiation with one another such that the first lighting radiation us only transmitted during the generation of the one of the first and second image signals, i.e. only during the generation of the first image signals or during the generation of the second image signals. The first light radiation (e.g. in accordance with a predefined or adjustable spatial pattern) is thus only transmitted for the signal generation by one of the two image sensors so that the corresponding image information is only contained in the image signals of this image sensor. Said first lighting radiation can thus in particular also comprise visible wavelengths.

In accordance with an advantageous further development, the lighting device explained above is furthermore adapted to transmit a second lighting radiation, with the synchronizing device furthermore being adapted also to synchronize the rotation of the mirror sector shutter and the transmission of the second lighting radiation with one another such that the second lighting radiation is only transmitted during the generation of the other of the first and second image signals, that is, for example, during the generation of the second image signals if the first lighting radiation is only transmitted during the generation of the first image signals. Completely or partly complementary lighting patterns can, for example, hereby be transmitted and/or completely or partly complementary wavelength ranges can be used. The first lighting radiation and the second lighting radiation can differ with respect to their wavelengths, for example. Alternatively, the first lighting radiation and the second lighting radiation can differ with respect to a spatial pattern of the respective lighting radiation, but not with respect to their wavelengths.

In the above-named embodiments (transmitting a lighting radiation), the motion picture camera can—in a manner similar to that already explained—have a signal processing unit associated with it which is adapted to determine depth information from a comparison of the lighting radiation transmitted by the lighting device with the image signals generated in a synchronized manner thereto or from a comparison of the first and second image signals.

In a further embodiment, the image signals of one of said image sensors are each associated with one of at least three receiving channels which correspond to different respective colors, in particular visible colors. For example, a Bayer filter or another color mosaic filter can be associated with this one of the image sensors so that the image sensor can generate image signals which correspond to a red color value or a green color value or a blue color value, for example, in accordance with the respective color filter. With other color mosaic filters, the image signals can also correspond to other colors or also to more than three colors such as cyan, yellow, magenta and white. These at least three channels can form one main image together.

In said embodiment, the image signals of the other of said image sensors can furthermore be associated with a further received channel. In this respect, this further channel can correspond to a further “color” such as infrared (in particular near infrared). This channel can, however, also have information which is not associated with any color such as depth information or sharpness/focus information, for example. The latter can in particular be the case when both image sensors are not arranged in one focal plane of the respective optical path leading to them (as will be explained in the following). Furthermore, the image signals of this other image sensor can also be associated with a respective one of a plurality of further channels; for example, when the other of said image sensors can sense both depth information and focal information on the scene to be recorded. These further channels of the other image sensor can form an auxiliary image together.

It thus results that the respective moving image can comprise at least three color channels having image information from image signals of the one image sensor as well as at least one further receiving channel having supplementary color information or other information from the image signals of the other of the two image sensors.

It is furthermore advantageous if the first image signals and the second image signals substantially correspond to the same spatial region of a scene to be recorded by means of the motion picture camera. Since the radiation incident onto the first image sensor and onto the second image sensor enters into the camera via a common reception optical path, it is ensured that the angle of view and further optical parameters of the imaging of the scene to be recorded onto the respective image sensor are identical for both image sensors. However, a certain offset can result between the image signals of the first and second image sensors from the respective position of the image sensors in the respective imaging optical path. This offset can in particular comprise a translation, a rotation and/or a scale difference. It is possible due to this offset that (slightly) different sections (i.e. spatial regions) of the scene to be recorded are sensed by the two image sensors. Such an offset is preferably essentially not present, which can in particular be achieved by a precise arrangement of the image sensors in their respective imaging optical path. Such an alignment can in particular be part of an adjustment in the production of the motion picture camera.

In a further development, the motion picture camera can have a signal processing unit which is adapted to compensate differences between the first image signals and the second image signals with respect to the respective spatial region to which they correspond. Such deviations can in particular comprise said offset between the section of the recorded scene sensed by the first or second image sensor. It is possible due to the manufacture that such an offset cannot be completely avoided. It is advantageous in such a case if the extent of the offset and/or optionally of a distortion between the image signals of the two images sensors are determined by means of the signal processing unit and can, for example, be electronically compensated in that the image signals of one or both image sensors are adapted to the image signals of the respective other image sensor or to one another, for example by equalization and opposing offsetting. Such an adaptation can in particular also take place when a relay optics is used such as will be explained in the following.

It can advantageously be achieved by such a geometrical registering of the image signals to one another that an image signal of one of the image sensors in one respective moving image and the image signal of the other image sensor located at the same position in the moving image correspond to the same spatial point in the scene to be recorded. It is thus possible with the aid of the signal processing unit to generate moving images from the image signals of two image sensors, said moving images having a plurality of channels registered to one another, in particular three color channels and one further channel with supplementary information. Said signal processing unit for compensating said deviations can in this respect be the previously named signal processing unit for determining depth information or a separate signal processing unit independent thereof.

It is possible in all of the aforesaid embodiments that said signal processing unit (for determining spatial depth information and/or for the geometrical registration of the first and second image signals) is part of the camera. This is, however, not absolutely necessary. The invention rather also relates to a camera system having a motion picture camera of the explained kind and having an independent signal processing unit of the explained kind.

In a further embodiment, the first image sensor is arranged in a focal plane of the first imaging optical path and the second image sensor is arranged in a focal plane of the second imaging optical path corresponding to the focal plane of the first imaging optical path. In this connection “corresponding” means that the focal plane of the one optical path substantially results from the mirroring of the focal plane of the other optical path at the mirror sector shutter and, optionally, at further mirrors serving for the deflection of the respective optical path. In this respect, however, certain deviations in the position of the focal plane may have to be taken into account which can in particular result due to different optical elements in the respective optical paths and/or also from the fact that radiation of different wavelengths, for example infrared radiation versus visible light, is refracted by different amounts at lenses (different optical path length).

It is possible alternatively to this that the one of the two image sensors is arranged in a focal plane of the associated imaging optical path. However, the other of the two image sensors in this embodiment can be arranged directly at a specific spacing from the focal plane of the associated imaging optical path to acquire focal information from the blur in the image signals of this image sensor caused in this manner. This focal information can be used for assisting the focusing work, either in the form of an autofocus function or for the presentation of depth information on a monitor. Said other of the two image sensors can in particular be an image sensor in this embodiment which is sensitive in a spectral range outside visible light. It can, however, also be of advantage if in this embodiment the first image sensor and the second image sensor are substantially sensitive in the same spectral range (in particular for visible light) so that the two image sensors only differ with respect to their spacing from the focal plane of the respective imaging optical path.

In a further embodiment, the one of said image sensors is arranged in a focal plane of the respective imaging optical path and a relay optics is arranged in the other imaging optical path and the other of said image sensors is arranged in the focal plane of said relay optics. The intermediate optical image, which is generated in the actual focal plane of said other imaging optical path, is imaged into a further focal plane by the relay optics. The corresponding other image sensor can then be arranged in this further focal plane. The relay optics thus makes it possible to modify the optical imaging properties of one of the two imaging optical paths with respect to the other one. The relay optics can in particular serve by a suitable dimensioning and placing to increase or decrease the imaging of the recorded scene onto one of the image sensors. In this manner, the first and the second image sensors can differ in size and nevertheless sense the same section of the scene to be recorded.

The object of the invention is also satisfied by a method for taking a sequence of moving images by means of a digital motion picture camera of said kind. In this respect, the method can comprise the following steps: rotating the mirror sector shutter, wherein radiation entering into the camera along the received optical path is alternately transmitted in the direct of the first imaging optical path to the first image sensor and deflected in the direction of the second imaging optical path to the second image sensor; generating first and second image signals by the respective image sensors during a respective interval of rotation of the mirror sector shutter; and generating a respective moving image from the first and second image signals of the same respective interval of rotation of the mirror sector shutter, wherein the respective moving image has at least one first channel with which the first image signals are associated and at least one second channel with which the second image signals are associated.

Said interval of rotation can in this respect preferably correspond to a full revolution of the mirror sector shutter. However, in particular with a mirror sector shutter having more than two sectors, which therefore comprises a plurality of radiation-permeable sectors and a plurality of radiation-impermeable sectors, other interval of rotations are also conceivable (e.g. corresponding to half a revolution of the mirror sector shutter). The image signals of one of the two image sensors are preferably each associated with one of at least three color channels, whereas the image signals of the other image sensor are associated with at least one channel having supplementary information, for example with an infrared channel or another color channel, with a depth channel or with a focus channel.

It is furthermore advantageous for the first and second image signals from which a respective moving image is generated to be geometrically registered to one another prior to the generation of the respective moving image. This process corresponds to the above-named compensation of a deviation between the two image sensors with respect to the respective sensed section of the scene to be recorded and can in particular be carried out by a signal processing unit provided for this purpose. The required measure of correction, for example equalization and/or offsetting, of the respective image signals, is substantially constant. The measure of correction then does not have to be repeatedly determined for every individual moving image, but can rather, for example, be determined within the framework of a calibration only once for a respective sequence of moving images or even only once for a motion picture camera. After such a calibration, the correction can then be applied uniformly to all moving images.

In a further embodiment, for improving a respective moving image, at least one channel with which first image signals are associated are modified on the basis of at least one channel with which the second image signals are associated, or vice versa. The image signals of the one image sensor can thus be used to improve image signals of the other image sensor, with said improvement in particular being able to comprise a correction of unwanted interference in the image signals or also the direct use of stylistic effects.

For example, the image signals of the one image sensor, which is at least sensitive in the spectral range of visible light and can thus sense visible image information, can be modified using the image signals of the other image sensor which is sensitive in an infrared, in particular near infrared spectral range. A color mosaic filter for sensing a plurality of colors of the visible spectral range in a respective color channel can in particular be associated with one of the image sensors with such an embodiment, whereas the other image sensor (in particular also with otherwise the same sensor properties such as dynamics, noise, sensitivity) can be configured with one channel (in particular without a color mosaic filter). A higher detail resolution can then be achieved in the individual channel than in the respective color channels of the other image sensor since all the pixels of the respective image sensor are associated with the individual channel, whereas only the pixels of the respective image sensor respectively corresponding to this color are associated with the color channels.

Said modification of the visible image signals of the one image sensor using the infrared image signals of the other image sensor can be useful for a variety of purposes of which three will be shown by way of example in the following.

One possible purpose is the elimination of unwanted infrared portions in the image signals of an image sensor which is actually intended to sense only image information of the visible spectral range. If an infrared filter is dispensed with or with an insufficiently sharp transition of such an infrared filter, infrared portions can, however, falsify the visible image information. Since the infrared image information is sensed separately by a further sensor, its image signals can then be utilized to remove the infrared portions from the image signals of the other sensor.

A further purpose is to put greater emphasis on regions of the recorded scene which are in particular blurred or unclear due to haze. The fact is utilized in this respect that infrared radiation at haze is scattered to a lesser degree than visible radiation, in particular blue radiation. A modification of the image signals of an image sensor sensitive in the visible spectral range, in particular of the image signals associated with a blue color channel, can therefore be used on the basis of the image signals of a sensor sensitive in the infrared spectral range for an improvement of the detail information in the regions of the scene to be recorded which are otherwise blurred by haze.

Infrared image information sensed by means of one of the image sensors can furthermore serve for the modification of the appearance and in particular of the perceived age of a person (i.e. of an actor). The infrared radiation transmitted from the face of a person as thermal radiation is very much more uniform than the visible radiation reflected by the face in which in particular wrinkles and impurities of the skin are more clearly recognizable. A first intermediate image having coarse structures with soft lines can be generated, for example, by spatial low pass filtering of the visible image (soft focus). Furthermore, the image details can be emphasized by spatial high pass filtering of the infrared image in a second intermediate image. Finally, a linking of these two intermediate images to form a new image can take place in which the main surface of faces can appear smoothed and thus a perceived younger appearance of the person can be achieved. The impression of a perceived ageing can conversely also be brought about in a similar manner.

Said modification of the image signals of the one image sensor does not necessarily have to be based on color information from the image signals of the other image sensor. Depth information from the image signals of the other image sensor can also be taken into account, for example, in order directly to make regions of the moving image sharper which correspond to a certain depth and to make other regions more blurred which correspond to other depths. Regions of the moving image can in this way be emphasized against a background and/or foreground.

In a further development, the moving images of at least one part of the sequence of moving images are modified to different degrees in dependence on their sequence in time. The change in the modification can in this respect in particular take place continuously over a specific time period of the sequence of moving images. Further artistic and design effects can be achieved in this manner. For example, the impression of incipient or disappearing fog can be caused directly by a gradual use of said method for compensating haze in the moving images. A further example is the artificially accelerated ageing or rejuvenation of persons by means of a temporally variable addition of portions of infrared image signals such as was described above.

Provision is made in a further embodiment of the method that a lighting device associated with the motion picture camera transmits radiation during the taking of a sequence of motion pictures. In this embodiment, depth information can be determined for a respective moving image from a comparison of the transmitted radiation with the image signals of one of said image sensors in whose spectral range the transmitted radiation is incident. This can take place, for example, in accordance with the already described manner by means of a signal processing unit. The depth information can furthermore be associated with the respective moving image as a separate channel. In this manner, a moving image produced in accordance with the method can have a further channel with depth information in addition to channels which comprise visible image information, with the channels advantageously being registered to one another. Every individual moving image then represents a color relief image of the scene to be recorded.

It is furthermore advantageous to mark individual objects or a plurality of objects or points within a scene to be recorded by radiation or color markings of a wavelength to which one of said image sensors is sensitive, but to which the other one of said image sensors is not sensitive. The term “color marking” is in this connection not restricted to visible light, but also comprises a non-visible spectral range (in particular infrared). The marking of the objects or points of the scene to be recorded can take place, for example, by projection by means of a lighting device associated with the motion picture camera in that the lighting device transmits radiation to the objects or points.

Alternatively, objects or points of the scene to be recorded can be physically provided with color markings. These color markings (preferably not visible, in particular infrared) can, for example, be stuck on or can be applied as a color, also as make-up on persons. It is preferred that these color markings can reflect or remit radiation of a wavelength to which one of said image sensors is sensitive, but the other is not. A remission is understood in this connection as an absorption and repeat emission of radiation which can in particular be accompanied by a wavelength shift. In particular actively radiating markings can be used, for example in the form of light emitting diodes, for a particularly reliable marking. Color markings applied to the objects or persons have the advantage with respect to the marking of the objects and points by means of radiation projected on that moving objects or points do not have to be tracked, but carry their marks along with them.

The position of such marked objects or points of a scene to be recorded can be sensed by the image sensor in whose spectral range the wavelength of the color markings or of the radiation transmitted for the marking is incident and can be integrated into the respective moving images as supplementary information on the image signals of the other image sensor which preferably senses visible image information on the scene to be recorded. This position information is in particular useful in the linking of the moving images with artificially generated image information, for example the insertion of an actor into a visual landscape, or in motion capture.

### BRIEF DESCRIPTION OF THE DRAWINGS

The invention will be explained only by way of example in the following with reference to the drawings.

FIG. 1 shows an embodiment of a motion picture camera in accordance with the invention in a schematic cross-sectional representation;

FIG. 2 shows a further embodiment of a motion picture camera in accordance with the invention in a schematic cross-sectional representation;

FIG. 3 shows an embodiment of a motion picture camera in accordance with the invention with an associated lighting device in a simplified schematic representation; and

FIG. 4 shows a further embodiment of a motion picture camera in accordance with the invention in a schematic cross-sectional representation.

### DETAILED DESCRIPTION OF THE PREFERRED EMBODIMENTS

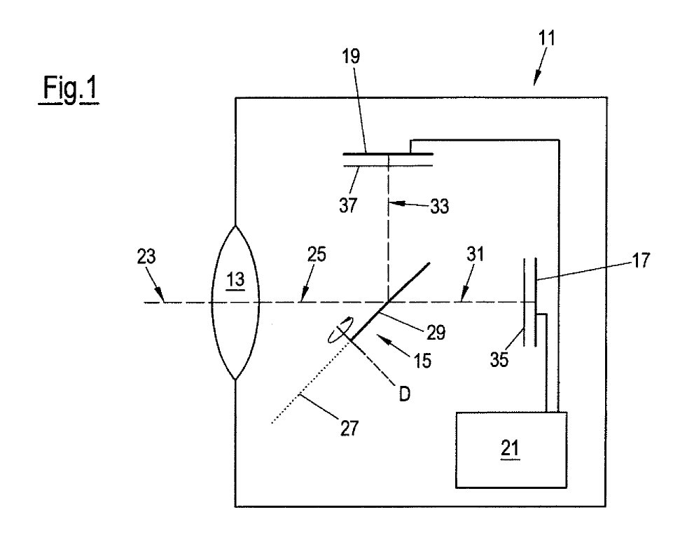

Only some essential elements of the embodiment of a motion picture camera 11 in accordance with the invention are shown in FIG. 1 for reasons of simplification. They include an objective 13, a mirror sector shutter 15, a first image sensor 17, a second image sensor 19 as well as a signal processing unit 21.

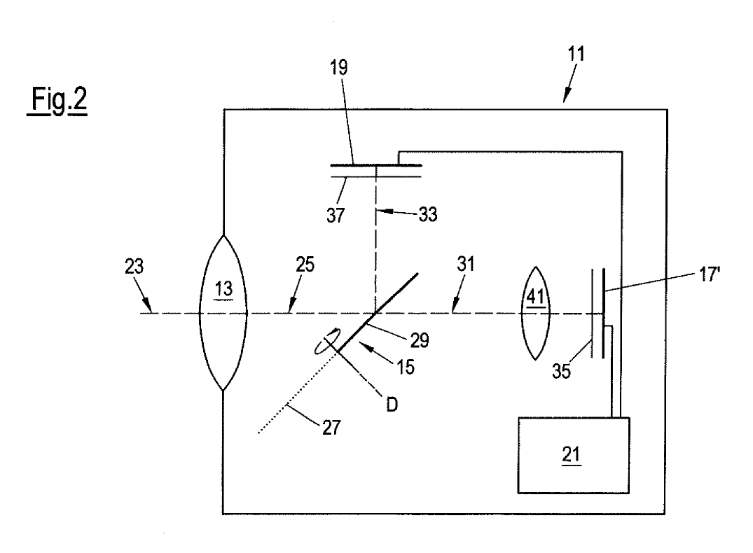

Radiation 23 transmitted or reflected from a scene to be recorded (not shown in FIGS. 1 and 2) enters through the objective 13 into the motion picture camera 11 and is conducted along a received optical path 25 to the mirror sector shutter 15. The mirror sector shutter 15 is configured as a circular disk and is rotatably supported about an axis of rotation D which extends perpendicular to the plane of extent of the mirror sector shutter 15 through its center. The mirror sector shutter 15 can rotate at different rotational frequencies about the axis of rotation D (cf. arrow). The mirror sector shutter 15 has a radiation-permeable sector 27 and a radiation impermeable sector 29 which both, for example, have a central angle of 180°. A different angular division can also be provided. The radiation-impermeable sector 29 is at least partly reflective at its side facing the objective 13.

The radiation 23 conducted along the received optical path 25 to the mirror sector shutter 15 is transmitted to the first image sensor 17 or deflected to the second image sensor 19 in dependence on the respective rotational position of the mirror sector shutter 15. If the radiation-permeable sector 27 of the mirror sector shutter 15 is located in the received optical path 25, the radiation 23 is transmitted and is conducted along a first imaging optical path 31 to the first image sensor 17. If, in contrast, the radiation 23 is incident onto the reflective radiation-impermeable sector 29 of the mirror sector shutter 15, it is deflected and is conducted along a second imaging optical path 33 to the second image sensor 19. The image sensors 17, 19 are in this respect arranged substantially in the focal plane of their respective imaging optical paths 31, 33. The received optical path 25 is therefore split by the mirror sector shutter 15 into the first and second imaging optical paths 31, 33, with the radiation 23 entering into the motion picture camera 11 alternately being conducted to the first and second image sensors 17, 19.

A respective filter 35, 37 is associated with both image sensors 17, 19, with a filter 35 for the spectral range of visible light being associated with the first image sensor 17 and a filter 37 for the spectral range of near-infrared light being associated with the second image sensor 19. The filter 35 of the first image sensor 17 is furthermore a color mosaic filter with a Bayer pattern so that a red, green or blue filter element is associated with each individual sensor element (not shown).

The first and second image sensors 17, 19 convert the respective radiation 23 incident onto them into first and second image signals. Due to the filter 35, the first image signals in this respect correspond to visible image information and can be associated with a red channel, a green channel or a blue channel in accordance with their position in the color mosaic of the filter 35. The second image signals which are generated by the second image sensor 19 correspond to infrared information and can be associated with a further, separate channel for infrared color information.

The two image sensors 17, 19 are connected to a signal processing unit 21 of the motion picture camera 11 which receives the first and second image signals and is adapted to electronically compensate deviations between the first and second image signals with respect to the respective spatial region of the recorded scene which they correspond to (so-called geometrical registration).

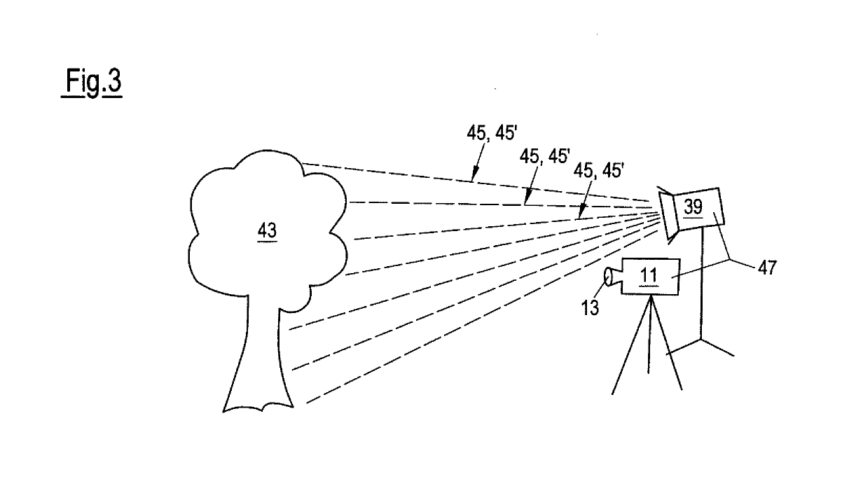

The radiation 23 entering into the motion picture camera 11 can also comprise near-infrared radiation 45 which is transmitted by a lighting device 39 associated with the motion picture camera 11 (not shown in FIG. 1, cf. FIG. 3). Due to this filter 35, this transmitted radiation 45, however, does not reach the first image sensor 17. In contrast, the near-infrared radiation 45 can pass through the filter 37 and act on the second image sensor 19 where it is converted into second image signals. The signal processing unit 21 can receive the second image signals having the infrared image information from the second image sensor 19 and can determine depth information from a comparison of the radiation transmitted by the lighting device 39 (FIG. 3) with the second image signals of the second image sensor 19. This depth information can then be associated with a channel alternatively or additionally to the infrared color information. In this manner, a respective moving image taken by the motion picture camera 11 comprises three color channels from the first image signals of the first image sensor 17 as well as one infrared color channel and/or a depth channel from the second image signals of the second image sensor 19.

The embodiment of a motion picture camera 11 shown in FIG. 2 differs from the embodiment shown in FIG. 1 substantially in that it additionally has a relay optics 41 which is arranged, for example, in the first imaging optical path 31. The intermediate image of the scene to be recorded which is generated in the original focal plane of the first imaging optical path 31 is imaged into a further focal plane by this relay optics. It is thereby in particular made possible to use two image sensors 17′, 19 of different sizes. Whereas the two image sensors 17, 19 in FIG. 1 have the same size, the first image sensor 17′ shown in FIG. 2 is, for example, smaller than the second image sensor 19. Nevertheless, due to the common received optical path 25 as well as the relay optics 41, it can be ensured that the image signals of the two image sensors 17′, 19 substantially correspond to the same section (i.e. spatial region) of the scene to be recorded.

The relay optics 41 can generally also be provided in the second imaging optical path 33 instead of the first imaging optical path 31, in particular to be able to use an infrared image sensor 19 which is smaller than the image sensor 17 provided for the visible spectral range.

An embodiment of a camera system having a motion picture camera 11 in accordance with the invention is also shown in FIG. 3, with the motion picture camera 11 here being shown in a very simplified manner. The objective 13 of the motion picture camera 11 is directed to a scene to be recorded which is symbolized by an object 43 (e.g. a tree). The camera system furthermore comprises the already mentioned lighting device 39. The object 43 is lit with transmitted near-infrared radiation 45 by means of the lighting device 39 associated with the motion picture camera 11. This lighting takes place in this respect with time modulation at a frequency of 20 MHz, for example. The transmitted radiation 45 is inter alia also reflected from the object 43 to the motion picture camera 11 and enters there through the objective 13 along the received optical path 25 (not shown here) into the motion picture camera 11. The motion picture camera 11 in this respect corresponds to an embodiment as shown in FIG. 1 or FIG. 2. It therefore comprises a first image sensor 17 which is sensitive to visible light and whose image signals therefore have visible image information on the object 43 and a second image sensor 19 which is sensitive to the transmitted near-infrared radiation 45.

The lighting device 39 is preferably arranged in a constant spatial arrangement relative to the motion picture camera 11. Differing from the representation in FIG. 3, the lighting device 39 can for this purpose be directly rigidly coupled to the motion picture camera 11. The lighting device 39 is electrically connected to the motion picture camera 11, in particular to the signal processing unit 21 (not shown here) in the motion picture camera 11, to allow a synchronization between the transmitted modulation and the modulation of the transmitted radiation 45 sensed by the second image sensor 19. The connection takes place here by means of a cable 49; it can, however, also take place by radio or via a separate common clock. The signal processing unit 21 can then determine the time duration between the transmission and the reception of the transmitted radiation 45, and can then determine the path distance covered from this, for every point of the scene to be recorded and in particular of the object 43 from a phase shift between the transmitted and the received modulation. In this manner, the image signals of the second image sensor 19 can contribute depth information to the moving image taken by the motion picture camera 11.

The lighting device 39 in accordance with FIG. 3 can alternatively also be provided for transmitting at least one first lighting radiation 45 and one second lighting radiation 45′ which, for example, comprise both wavelengths of the same visible spectral range or both wavelengths of the same infrared spectral range, but can differ with respect to a spatial pattern of the respective lighting radiation 45, 45′. The signal processing unit 21 further simultaneously serves as a synchronizing device which synchronizes the rotation of the mirror sector shutter 15 of the motion picture camera 11 and the transmission of the first lighting radiation 45 and of the second lighting radiation 45′ with one another. This synchronizing takes place such that the first lighting radiation 45 is only transmitted during such a time interval in which the mirror sector shutter 15 transmits the received optical path 25 of the motion picture camera 11 (cf. FIG. 1) as the first imaging optical path 31 (for the generation of the first image signals), whereas the second lighting radiation 45′ is only transmitted during such a time interval in which the mirror sector shutter 15 deflects the received optical path 25 of the motion picture camera 11 as the second imaging optical path 33 (for the generation of the second image signals). The lighting device 39 can have two different radiation sources (not shown) for the two different lighting radiations (45, 45′) which light the object 43 preferably spatially spaced apart from one another from different angles. Depth information can be determined in the already explained manner (comparison of the first and second image signals) from the additional image information hereby obtained.

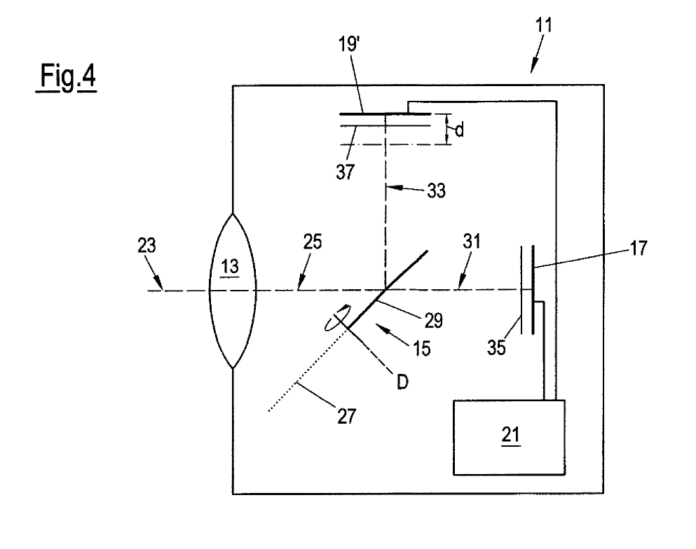

The embodiment of a motion picture camera 11 shown in FIG. 4 finally differs from the embodiment shown in FIG. 1 in that the second image sensor 19′ is arranged at a spacing d from the focal plane of the associated imaging optical path 33. The first image sensor 17, in contrast, is (as in FIG. 1) arranged in the focal plane of the associated imaging optical path 31. A certain blur with respect to the imaging of the object 43 (FIG. 3) is thus directly generated for the second image sensor 19′. By comparing the first image signals of the first image sensor 17 with the second image signals of the second image sensor 19′, the associated signal processing unit 21 can gain focal information which can be utilized, for example, for a focusing device of the motion picture camera 11 or for determining depth information.

A combination with the embodiment in accordance with FIG. 2 is also possible, i.e. a relay optics 41 can be provided in one of the imaging optical paths 31, 33 in accordance with FIG. 4.

1. A digital motion picture camera (11) for taking a sequence of moving images, comprising:
a rotating mirror sector shutter (15) which alternately transmits a received optical path (25) of the motion picture camera (11) as a first imaging optical path (31) and deflects the received optical path (25) as a second imaging optical path (33);
a first image sensor (17) arranged in the first imaging optical path (31) for generating radiation-dependent first image signals; and
a second image sensor (19) arranged in the second imaging optical path (33) for generating radiation-dependent second image signals.

2. A motion picture camera in accordance with claim 1,
wherein the first image sensor (17) is sensitive in a first spectral range and the second image sensor (19) is sensitive in a second spectral range, and wherein the first spectral range and the second spectral range are partly or completely different.

3. A motion picture camera in accordance with claim 2,
wherein one of said first and second spectral ranges substantially comprises a spectral range of visible light and the other of said first and second spectral ranges substantially comprises a spectral range of infrared radiation.

4. A motion picture camera in accordance with claim 2,
wherein a lighting device (39) is associated with the motion picture camera (11) and is adapted to transmit radiation (45) of a wavelength which is contained in one of said first and second spectral ranges and which is not contained in the other of said first and second spectral ranges.

5. A motion picture camera in accordance with claim 4,
wherein the lighting device (39) is adapted to mark with the transmitted radiation (45) individual objects or a plurality of objects (43) or points within a scene to be recorded by means of the motion picture camera (11).

6. A motion picture camera in accordance with claim 4,
wherein the lighting device (39) is adapted to transmit the radiation (45) in accordance with a predefined or adjustable spatial pattern.

7. A motion picture camera in accordance with claim 4,
wherein the lighting device (39) is adapted to transmit the radiation in a predefined or adjustable manner with time modulation.

8. A motion picture camera in accordance with claim 4,
wherein a signal processing unit (21) is associated with the motion picture camera (11) and is adapted to determine depth information from a comparison of the radiation (45) transmitted by the lighting device (39) with the image signals of the one of said first and second image sensors (17, 19) in whose spectral range of sensitivity said wavelength of the transmitted radiation (45) is contained.

9. A motion picture camera in accordance with claim 1,
wherein the first image sensor (17) is sensitive in a first spectral range and the second image sensor (19) is sensitive in a second spectral range, wherein the first spectral range and the second spectral range are different and wherein one of said first and second spectral ranges substantially comprises a spectral range of visible light and the other of said first and second spectral ranges substantially comprises a spectral range of infrared radiation; and
wherein a lighting device (39) is associated with the motion picture camera (11) and is adapted to transmit infrared radiation (45).

10. A motion picture camera in accordance with claim 9,
wherein the lighting device (39) is adapted to mark with the transmitted infrared radiation (45) individual objects or a plurality of objects (43) or points within a scene to be recorded by means of the motion picture camera (11).

11. A motion picture camera in accordance with claim 9,
wherein the lighting device (39) is adapted to transmit the infrared radiation (45) in accordance with a predefined or adjustable spatial pattern.

12. A motion picture camera in accordance with claim 9,
wherein the lighting device (39) is adapted to transmit the infrared radiation in a predefined or adjustable manner with time modulation.

13. A motion picture camera in accordance with claim 9,
wherein a signal processing unit (21) is associated with the motion picture camera (11) and is adapted to determine depth information from a comparison of the infrared radiation (45) transmitted by the lighting device (39) with the image signals of one of said first and second image sensors (17, 19).

14. A motion picture camera in accordance with claim 1,
wherein a lighting device (39) for transmitting at least one first lighting radiation (45) and a synchronizing device (21) are associated with the motion picture camera (11), wherein the synchronizing device (21) is adapted to synchronize the rotation of the mirror sector shutter (15) and the transmission of the first lighting radiation (45) with one another such that the first lighting radiation (45) is only transmitted during the generation of one of the first and second image signals.

15. A motion picture camera in accordance with claim 14,
wherein the first lighting radiation (45) comprises visible wavelengths.

16. A motion picture camera in accordance with claim 14,
wherein the lighting device (39) is further adapted to transmit a second lighting radiation (45′), with the synchronizing device (21) further being adapted to synchronize the rotation of the mirror sector shutter (15) and the transmission of the second lighting radiation (45′) with one another such that the second lighting radiation (45′) is only transmitted during the generation of the other of the first and second image signals.

17. A motion picture camera in accordance with claim 16,
wherein the first lighting radiation (45) and the second lighting radiation (45′) differ with respect to their wavelengths.

18. A motion picture camera in accordance with claim 16,
wherein the first lighting radiation (45) and the second lighting radiation (45′) differ with respect to a spatial pattern of the respective lighting radiation (45, 45′), but not with respect to their wavelengths.

19. A motion picture camera in accordance with claim 14,
wherein a signal processing unit (21) is associated the motion picture camera (11) which is adapted to determine depth information from a comparison of the lighting radiation (45, 45′) transmitted by the lighting device (39) with the image signals generated in synchronicity herewith or from a comparison of the first and second image signals.

20. A motion picture camera in accordance with claim 1,
wherein the image signals of one of said first and second image sensors (17, 19) are associated with at least three different channels which correspond to respective different colors, and wherein the image signals of the other of said first and second image sensors (17, 19) are associated with a further channel.

21. A motion picture camera in accordance with claim 1,
wherein the first image signals and the second image signals substantially correspond to the same spatial region of a scene to be recorded by means of the motion picture camera (11).

22. A motion picture camera in accordance with claim 1,
wherein the motion picture camera (11) has a signal processing unit (21) which is adapted to compensate differences between the first image signals and the second image signals with respect to the respective spatial region which they correspond to.

23. A motion picture camera in accordance with claim 1,
wherein the first image sensor (17) is arranged in a focal plane of the first imaging optical path (31) and the second image sensor (19) is arranged in a focal plane of the second imaging optical path (33) corresponding to the focal plane of the first imaging optical path (31).

24. A motion picture camera in accordance with claim 1,
wherein one of said first and second image sensors (17, 19) is arranged in a focal plane of the associated imaging optical path (31, 33); and wherein the other of said first and second image sensors (17, 19) is arranged at a spacing from a focal plane of the associated imaging optical path (31, 33).

25. A motion picture camera in accordance with claim 1,
wherein one of said first and second image sensors (17, 19) is arranged in a focal plane of the associated optical path (31, 33); and wherein a relay optics (41) is arranged in the other imaging optical path (31, 33), with the other of said first and second image sensors (17, 19) being arranged in the focal plane of the relay optics.

26. A method for taking a sequence of moving images by means of a digital motion picture camera (11) comprising a rotating mirror sector shutter (15), a first image sensor (17) and a second image sensor (19), the method comprising the steps of:
rotating the mirror sector shutter (15), wherein radiation (23) entering into the motion picture camera along the received optical path (25) is alternately transmitted in the direction of a first imaging optical path (31) to the first image sensor (17) and deflected in the direction of a second imaging optical path (33) to the second image sensor (19);
generating radiation-dependent first and second image signals by the first and second image sensors (17, 19), respectively, during a respective interval of rotation of the mirror sector shutter (15); and
generating a respective moving image from the first and second image signals of the same respective interval of rotation of the mirror sector shutter (15), wherein the respective moving image has at least one first channel with which the first image signals are associated and at least one second channel with which the second image signals are associated.

27. A method in accordance with claim 26,
wherein the first and second image signals from which a respective moving image is generated are geometrically registered to one another prior to the generation of the respective moving image.

28. A method in accordance with claim 26,
wherein at least one channel with which the first image signals are associated is modified on the basis of at least one channel with which the second image signals are associated, or vice versa, for improving a respective moving image.

29. A method in accordance with claim 28,
wherein the moving images of at least one part of the sequence of moving images are modified to different degrees in dependence on their sequence in time.

30. A method in accordance with claim 26,
wherein the first image sensor (17) is sensitive in a first spectral range and the second image sensor (19) is sensitive in a second spectral range, wherein the first spectral range and the second spectral range are partly or completely different;
wherein a lighting device (39) transmits radiation (45) during the taking of a sequence of moving images, wherein the transmitted radiation (45) comprises a wavelength which is contained in one of said first and second spectral ranges and which is not contained in the other of said first and second spectral ranges; and
wherein depth information is determined and is associated with the respective moving image as a further channel from a comparison of the transmitted radiation (45) with the image signals of the one of said first and second image sensors (17, 19) in whose spectral range of sensitivity said wavelength of the transmitted radiation (45) is contained.

31. A method in accordance with claim 26,
wherein individual objects or a plurality of objects (43) or points within a scene to be recorded by the motion picture camera (11) are marked by radiation (45) or by color markings of a wavelength to which one of said first and second image sensors (17, 19) is sensitive, but to which the other of said first and second image sensors (17, 19) is not sensitive.

32. A method in accordance with claim 26,
wherein a lighting device (39) transmits at least one first lighting radiation (45) towards a scene to be recorded by the motion picture camera (11), and wherein a synchronizing device (21) synchronizes the rotation of the mirror sector shutter (15) and the transmission of the first lighting radiation (45) with one another such that the first lighting radiation (45) is only transmitted during the generation of one of the first and second image signals.

33. A method in accordance with claim 32,
wherein the lighting device (39) further transmits a second lighting radiation (45′), wherein the synchronizing device (21) synchronizes the rotation of the mirror sector shutter (15) and the transmission of the second lighting radiation (45′) with one another such that the second lighting radiation (45′) is only transmitted during the generation of the other of the first and second image signals.
